(19) United States
(12) Patent Application Publication
(10) Pub. No.: US 2010/0308557 A1
(43) Pub. Date: Dec. 9, 2010

(54) Heat Shield for Motorcycle with Driver Footboards

(76) Inventor: John Douglas Pruit, Parker, CO (US)

Correspondence Address: John D. Prutt, 240 Pinecrest Cr., Bailey, CO, 80421, US

(21) Appl. No.: 12/469,406

(22) Filed: May 20, 2009

(51) Int. Cl. B62J 27/00

(52) U.S. Cl. 280/304.3

(57) ABSTRACT

A motorcycle heat shield arranged to be mounted above the between a motorcycle rider's footboard and the exhaust pipe. The heat shield is attachable to the motorcycle using the motorcycle axis bolt used to connect the footboard support arm and footboard.

### FIELD OF THE INVENTION

The present invention relates generally to motorcycle components and accessories.

### BACKGROUND

Motorcycles having gasoline engines generally have engines that are located at a forward position on the motorcycle underneath the gas tank, which is typically located to the front of the vehicle's seat. Most motorcycles can transport two people: an operator and a passenger. A pair of footboards is typically provided with one footboard on each side of the motorcycle for the operator. On most motorcycles, 1-4 exhaust pipes extend along one or both sides of the motorcycle to the rear thereof. Typically, on at least one side of the motorcycle, a folding footboard is located adjacent to one or more exhaust pipes.

Accordingly, given the foregoing a motorcycle driver places his/her feet on footboards that are located in close proximity to the exhaust pipe and muffler. The exhaust pipe and muffler become extremely hot during the use of the motorcycle, and often times a passenger unintentionally positions his/her foot against this exhaust pipe or muffler causing the passenger's clothing, footwear or even feet and ankles to be burned. In addition, there is heat that is radiated by the exhaust system that can very uncomfortable to the driver over time. Generally, an exhaust pipe extends along the inner side of the footboard and slightly below this footboard.

Heat guards or shields for use with motorcycles are known especially those intended for use with the footboards of a primary operator or passenger. For example, U.S. Pat. No. 6,179,313 by Christensen shows a motorcycle exhaust pipe heat guard having a planar configuration that is mounted between a primary rider footboard and the exhaust pipe. Christensen uses a two parallel arm clamp configuration to mount his guard to the foot peg or footboard mounting arm. Use of this mounting design on a footboard of some newer motorcycles would require the two arm clamp to be wrapped around the outer end of a tapered footboard mounting arm which is the only available space. On most motorcycles, there is an axis pin that holds the footboard to the footboard support. The purpose of this axis pin design is to allow the footboard or foot peg to swivel in an upward direction for storage when not in use. Christensen's design has two parallel arms which will bridge across the slot in the footboard or footboard support that was designed to allow pivotal motion. This parallel arm design causes interference in the manufactures collapsible footboard/foot peg design. My present invention does not depend on two parallel mounting arms. As such, my invention does not bridge across the pivotal mechanism of the foot peg or footboard and does not add these limits. My present invention allows footboards/foot pegs to freely collapse and function as they were designed.

Another example is U.S. Pat. No. 6,626,448 by Miles in which he differentiates his design from Christensen's by the fact that his guard is made of an “elongated rod” instead of planar design. This “elongated rod” design provides a bent portion with the option to go around the back of a rider's heel to keep it from sliding off of the peg. However, Miles uses the same mounting solution as Christensen and in doing so; adds the same limitations to the motorcycle manufacturer's design. Also, by using an “elongated rod” instead of a planer shield, Miles' slender material does not shield the rider against radiated heat. My present invention is a planer shield and not a rod. The planer shield has much greater surface area that blocks radiated heat from the motorcycle exhaust system and makes the ride more comfortable for the driver. In addition, my present invention has an integral and more secure mounting method.

Another example is U.S. Pat. No. 7,017,932 B1 which is a continuation-in-part of patent 6,626,448 also issued to Miles. In this patent, Miles broadens his original claims using the “elongated rod guard” by claiming an “elongated rode” mounted between the rider's foot and an exhaust pipe and introduces an additional design that does not impede the foot peg from being collapsed when the guard is installed and mounted at the outer end of the foot peg mounting arm. By making an “elongated rod” with the limited surface area of rod, Miles looses the ability to shield rider from the radiated heat of the exhaust pipe. In this embodiment of Mile's new mounting design he describes a heel guard made from two dependant parts where the cylindrical rod is mounted into a cylindrical hole of the mounting bracket. There is a small setscrew that is used to hold this rod in position. Because of the extremely limited contact area of this set screw onto the surface of the rod, there are models of motorcycles where the vibration of the motorcycle itself can cause this small set screw to loosen up thereby letting the rod rotate from its mounted position or even vibrate out of the receiving hole in the mounting arm completely while the motorcycle is in motion. Another embodiment of Mile's boot guard is a rod that has an L-shaped bracket that attaches the guard directly to the footboard. The limitation of this embodiment is that it requires that the user remove the footboard from the motorcycle and drill holes through the footboard in order to bolt the L-bracket to the footboard thereby holding the elongated rod in position. Drilling holes through the manufacturer's plated footboard introduces the possibility of rust where the plating has been compromises by the drilling of the holes. My present invention does not require drilling holes in order to mount to the motorcycle and has the mounting method integral with the design so there is no worry of the shield separating from the mount. In all of Miles' claims of an “elongated rod”, Miles has failed to protect the rider from the radiated heat generated by the exhaust system. Hence, my present invention addresses a motorcyclist's needs as no prior art has done. My present invention's planer shield configuration helps block this radiated heat from the extremely hot exhaust pipe that runs just inside the driver's foot. My present invention does not interfere with the mechanical design of the collapsing of footboards/foot pegs. My present invention has a mounting method which is more stable and does not require any modification to the motorcycle.

### DESCRIPTION OF DRAWINGS

In order that the invention may be clearly understood and readily carried into effect, a preferred embodiment of the invention will now be described, by the way of example only, with reference to the accompanying drawings wherein:

FIG. 1 is a front elevational view of the heat shield according to an embodiment of the present invention;

FIG. 2 is a back elevational view of the heat shield according to an embodiment of the present invention;

FIG. 3 is front elevational view a heat shield according to a second embodiment of the present invention;

FIG. 4 is a back elevational view of the heat shield according to a second embodiment of the present invention;

FIG. 5 is a front elevational view of a heat shield according to a third embodiment of the present invention;

FIG. 6 is a description of the mounting of an embodiment of the present invention to the existing prior art footboard.

FIG. 7 is a front elevational view of the heat shield of FIG. 5 which is expanded to a rear view in order to show detail of how the front section of an embodiment of the present invention is mounted to the prior art motorcycle footboard.

FIG. 8 is a plan view of the plate that can be used in forming an embodiment of the present invention;

### DESCRIPTION OF A PREFERRED EMBODIMENT

Embodiments of the present invention include a motorcycle heat shield comprising a shield portion and mounting portions for typical use on a footboard on motorcycles having an exhaust pipe running adjacent the driver's footboard. Variations of the heat shield comprise one or more planer sections, which help maintain a clearance between the user's foot including the heel and the contour of the exhaust pipe and larger diameter muffler. Further, in certain embodiments, a mounting portion is provided for mounting the shield at a position between the footboard and the motorcycle, and at an elevation above the footboard.

In variations, the shield and the integral mounting bracket portion are fabricated from sheet and/or plate stock that is subsequently bent and/or formed into their final configurations. The plate for the shield portion is in certain variations formed to follow the contour of the exhaust pipe that it is placed in front of. For instance, wherein the exhaust transitions from a relatively small diameter pipe to a larger diameter muffler, the heat shield may be configured accordingly to maintain a generally uniform distance from the exhaust system along its entire length. Additionally or alternatively, the heat shield can be curved to correspond to the curvature of the cylindrical exhaust pipes and/or muffler. The contouring helps maintain the heat shield a sufficient distance from the exhaust system while potentially improving the aesthetic appeal of the heat shield.

Embodiments of the present invention comprise a single piece heat shield fabricated from a planar piece of sheet stock that can be mounted to motorcycle frame using the existing floorboard support arm to footboard attachment bolt configuration designed by the manufacturer. This embodiment permits full pivotal movement of the footboard between stowed and deployed positions. In any of the various embodiments and variations, the various components of the heat shield assembly can be appropriately finished to blend in with or complement the motorcycle on which the components are mounted. For instance, the heat shields can be chromed, blued, painted, anodized, and/or coated.

### Terminology

The term “or” as used in this specification and the appended claims is not meant to be exclusive rather the term is inclusive meaning “either or both”. References in the specification to “one embodiment”, “an embodiment”, “a preferred embodiment”, “an alternative embodiment”, “one variation”, “a variations” and similar phrases mean that a particular feature, structure, or characteristic described in connection with the embodiment is included in at least an embodiment of the invention. The appearance of the phrase “in one embodiment” in various places in the specification are all not necessarily meant to refer to the same embodiment.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the terms “about” or “generally” as used herein unless otherwise indicated means a margin of +−35%. Also, as applicable, the term “substantially” as used herein unless otherwise indicated means a margin of +−10%. It is to be appreciated that not all uses of the above terms are quantifiable such that the referenced ranges can be applied.

### Single Piece Exhaust Heat Shield According to Embodiments

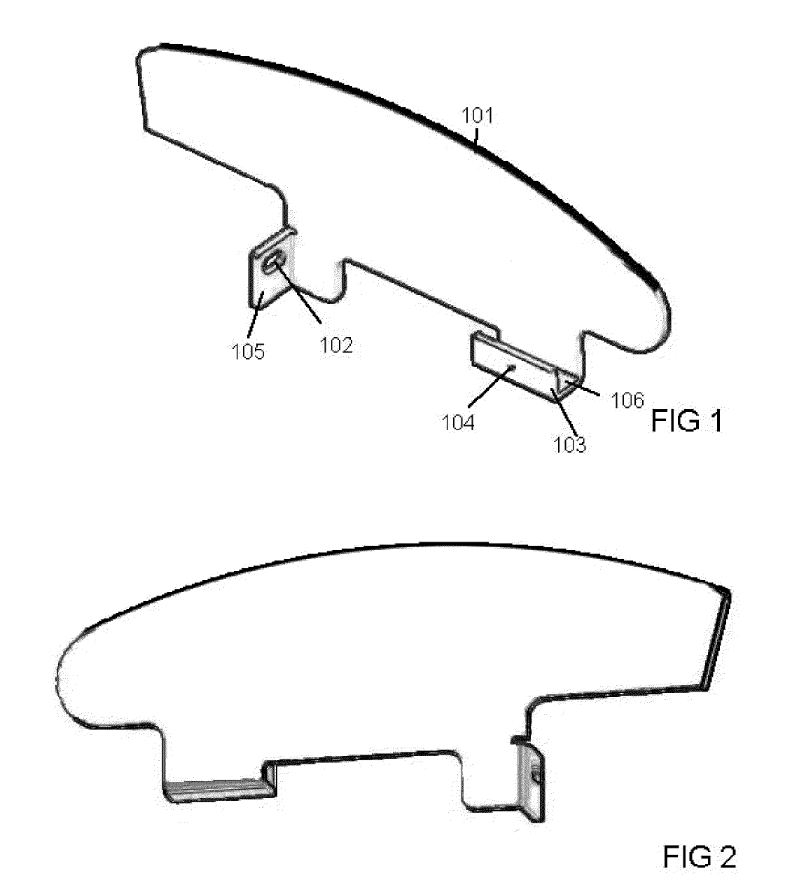

Embodiments of single piece heat shields are shown in FIGS. 1-7. FIG. 1 shows one variation of the heat shield 101 with the cylindrical hole 102 in an integral mounting arm portion 105 which provides means to attach the shield to the footboard bracket. Also shown is an integral side flange 106 and lip 103 on the top of the side flange 106. Also shown is the threaded hole 104 through lip 103.

FIG. 2 shows a back elevational view of the heat shield 101.

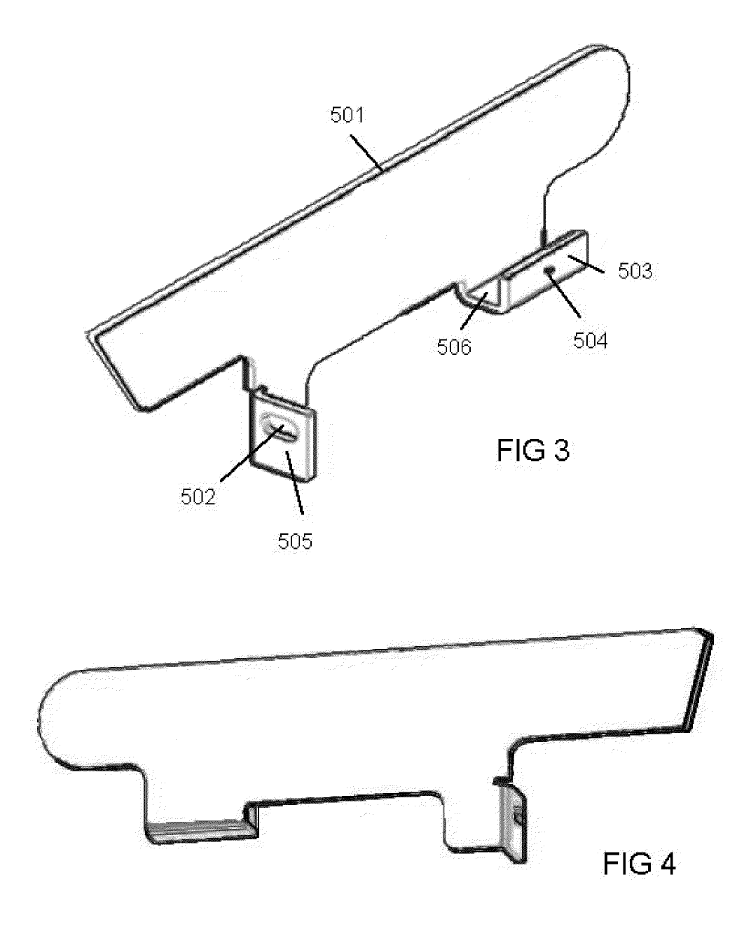

FIG. 3 shows a different variation of the heat shield 501 with the elongated cylindrical hole 502 in an integral mounting arm portion 505 which provides means to attach the shield to the footboard bracket. Also shown is an integral side flange 506 and lip 503 on the top of the side flange 506. Also shown is the threaded hole 504 through lip 503.

FIG. 4 shows a back side view of the heat shield 501 also shown in FIG. 3.

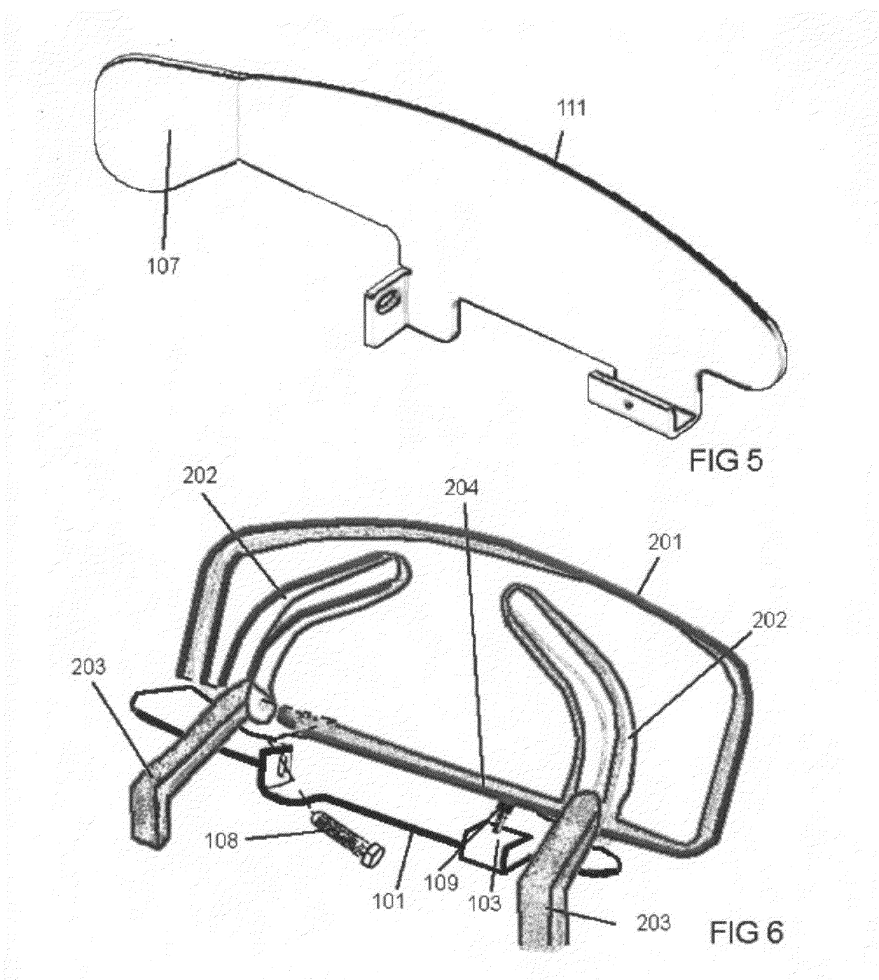

FIG. 5 shows a front elevational view of the heat shield 111. Also shown is an embodiment of the current invention where an acute angled plane 107 is shaped to follow the contour of an exhaust pipe as the pipe changes diameters and the plane 107 is bent away from the bike to accommodate this change.

FIG. 6 is a bottom view of shield 111 and how shield 111 is positioned to mount. The shaded areas show an existing art footboard 201, the footboard mounting bracket 202, the existing motorcycle footboard support arms 203, and the lower edge lip 204 of footboard 201. Also shown is axis pin 108 which is used to attach the rear section of the shield 101 to one side of the footboard rear mounting bracket 202 and through motorcycle support arm 203 allowing footboard 201 swivel on axis pin 108. Also shown is side lip 103 and bolt 109 which are used to secure the front section of shield 101 to the lower edge lip 204 of footboard 201.

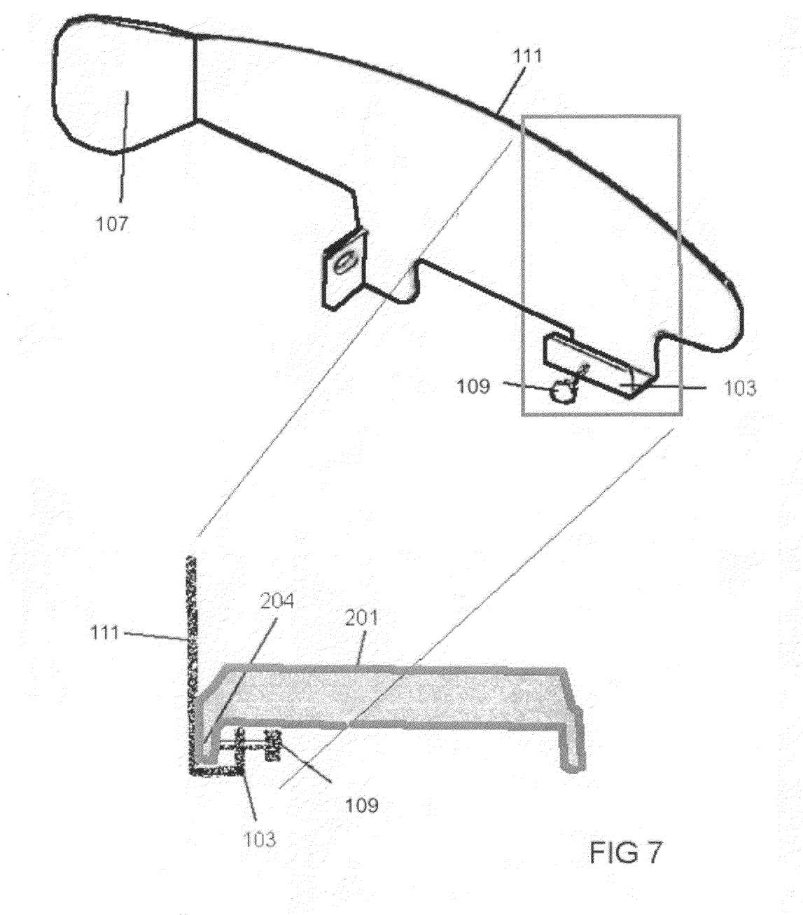

FIG. 7 is an illustration of an expanded view of how shield 111 is secured to the lower edge lip 204 of footboard 201. Side flange 106 creates a space between lip 103 and the lower shield body. By tightening bolt 109 that is threaded through 103, the lower edge lip 204 of footboard 201 can be compressed between the bolt stem and the lower shield body securely fastening the shield to the footboard.

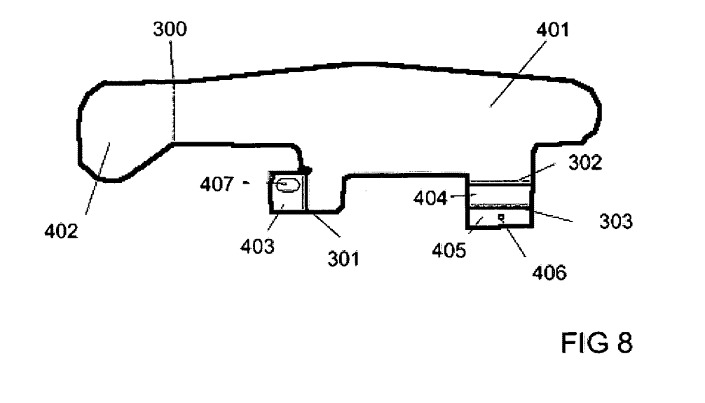

FIG. 8 shows a blank plate material 401 from which a single piece heat shield, such as illustrated in FIG. 5 can be fabricated. The plate or sheet is typically comprised of a steel alloy but may also comprise other materials, such as other metals or plastic. The blank can be made using any suitable means, such as machining or stamping, but in at least one variation the blank is laser cut from sheet stock.

The dashed lines 300, 301, 302, & 303 indicate lines of bending along which the blank 401 is bent to create the heat shield's final form. Creases may, but need not, be formed in the blank during the stamping operation to facilitate easier bending in a subsequent operation. The cylindrical hole 406 in the mounting portion section 405 can be formed during the stamping or laser operation or in a subsequent operation, such as by drilling. The elongated hole 407 in the mounting portion section 403 can be formed during the stamping or laser operation or in a subsequent operation, such as by drilling.

The blank is typically bent into final form using a brake. For instance, the mounting portion 403 is bent generally 90° upwardly relative to the horizontally positioning of sheet area 401. The integral side flange 404 is bent generally 90° upwardly relative to the horizontally positioned portion 401. The lip 405 is bent inwardly at generally 90° relative to the side flange 404. The heat shield portion 402 is bent upwardly relative to the distal end of the horizontal positioned 401.

Once the heat shield is fully formed, it is prepared for final finish. For instance, the unit may be tumbled in abrasive particles to deburr and break the rough edges. The unit may be cleaned and as necessary acid etched to prepare it to receive its final finish, such as chrome.

Further, variations are contemplated wherein the single piece heat shield is fabricated into its final form in a single operation, such as by casting of a metallic heat shield or injection molding of a reinforced or unreinforced polymeric material. Variations are also contemplated wherein the heat shield is molded of a carbon fiber laminate.

### Other Embodiments and Variations

The various embodiments and variations thereof illustrated in the accompanying figures and/or described above are merely exemplary and are not intended to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention. For instance, various features of the various heat shields, heat shield portions and mounting bracket portions can be interchanged as is practical and suitable.

I claim:

1. A planar heat shield for a rider on a motorcycle, comprising:
a motorcycle which is movable in fore-and-aft directions;
a footboard support arm extending on said motorcycle laterally of the fore-and-aft directions;
a footboard which is hinged via cylindrical axis bolt to the outer end of said footboard support arm and extending horizontally for supporting a foot of the rider;
a cylindrical axis bolt which allows the footboard to rotate from the down rider usage position where it extends away from the motorcycle into an upward collapsed position against the side of the motorcycle in the storage position;
said planer heat shield having means for mounting the shield at an elevation above the collapsible footboard and between the footboard and the motorcycle exhaust pipe;

2. A planar motorcycle exhaust system heat shield for a rider on a motorcycle, comprising:
a motorcycle which is movable in fore-and-aft directions;
a footboard support arm extending on said motorcycle laterally of the fore-and-aft directions;
a footboard which is hinged via cylindrical axis bolt to the outer end of said footboard support arm and extending horizontally for supporting a foot of the rider;
a cylindrical axis bolt which allows the footboard to rotate from the down rider usage position where it extends away from the motorcycle into an upward collapsed position against the side of the motorcycle in the storage position;
said planer heat shield having at least one integral bracket for mounting the shield at an elevation above the collapsible footboard and between the footboard and the motorcycle exhaust pipe; and
said bracket comprising a planar mounting arm disposed in a vertical plane laterally to the fore and aft direction; and
said planar heat shield being adapted to mount to the motorcycle using at least one of the axis bolts that secure the footboard to footboard support arm.

3. The planar motorcycle exhaust system heat shield of claim 1 comprising: a mounting arm portion, the mounting arm portion adapted to mount adjacent the surface of the footboard mounting bracket, the mounting arm portion including at least one hole opening extending therethrough to receive the axis bolt used in the footboard to footboard support.

4. The planar motorcycle exhaust system heat shield of claim 1, further comprising: a shield portion that extends in a forward direction.

5. The planar motorcycle exhaust system heat shield of claim 1, further comprising: a shield portion that extends in an aft direction.

6. The planar motorcycle exhaust system heat shield of claim 1, further comprising: a shield portion that extends in a forward and aft direction.

7. The planar motorcycle exhaust system heat shield of claim 2 comprising: a mounting arm portion, the mounting arm portion adapted to mount adjacent the surface of the footboard mounting bracket, the mounting arm portion including at least one hole opening extending therethrough to receive the axis bolt used in the footboard to footboard support.

8. The planar motorcycle exhaust system heat shield of claim 2, further comprising: a shield portion that extends in a forward direction.

9. The planar motorcycle exhaust system heat shield of claim 2, further comprising: a shield portion that extends in an aft direction.

10. The planar motorcycle exhaust system heat shield of claim 2, further comprising: a shield portion that extends in a forward and aft direction.

9. The planar motorcycle exhaust system heat shield of claim 1 that includes means to secure the heat shield to the footboard

10. The planar motorcycle exhaust system heat shield of claim 2 that includes means to secure the heat shield to the footboard

11. The planar motorcycle exhaust system heat shield heat shield of claim 1 that includes air circulating vents cut through the planar shield.

12. The planar motorcycle exhaust system heat shield heat shield of claim 2 that includes air vents cut through the planar shield.
